(19) United States
(12) Patent Application Publication
(10) Pub. No.: US 2026/0298166 A1
(43) Pub. Date: Oct. 1, 2026

(54) CONTROLLER AND CONTROL METHOD

(71) Applicant: TOYOTA JIDOSHA KABUSHIKI KAISHA, Toyota-shi (JP)

(72) Inventor: Tomokazu AKUTSU, Nagakute-shi (JP)

(21) Appl. No.: 19/537,528

(22) Filed: Feb. 12, 2026

(30) Foreign Application Priority Data
Mar. 28, 2025 (JP) 2025-056323

(51) Int. Cl. F02D 41/02; F02D 19/08; F02D 41/14

(52) U.S. Cl. CPC F02D 41/029; F02D 19/081; F02D 41/025; F02D 41/1454; F02D 2200/0812

(57) ABSTRACT

A controller controls an engine provided with a filter for collecting particulate matter in an exhaust pipe. The controller stores data of a first map outputting an amount of particulate matter emitted when using a first fuel, and data of a second map outputting an amount of particulate matter emitted when using a second fuel having a property different from the first fuel. The controller calculates a first deposition amount based on the output value from the first map and a second deposition amount based on the output value from the second map as the amount of particulate matter deposited on the filter while the engine is running. The controller executes the first process when the first deposition amount is greater than or equal to a first threshold value, and executes the second process when the second deposition amount is greater than or equal to a second threshold value.

### CROSS-REFERENCE TO RELATED APPLICATIONS

This application is based upon and claims the benefit of priority from Japanese Patent Application No. 2025-056323, filed on Mar. 28, 2025, the entire contents of which are incorporated herein by reference.

### BACKGROUND

### 1. Field

The present disclosure relates to a controller and a control method.

### 2. Description of Related Art

JP2005-48709A describes a controller for an engine. The engine includes an exhaust pipe provided with a filter that collects particulate matter in exhaust gas. Hereinafter, particulate matter may be referred to as PM. PM is an abbreviation of particulate matter.

The controller includes detection means for detecting a fuel property such as a cetane number of the fuel. The controller estimates the amount of PM deposited on the filter based on the fuel property detected by the detection means and the running state of the engine. Thus, the controller executes processes in accordance with the amount of PM deposited on the filter at appropriate time.

The controller needs to periodically detect the fuel property. In this regard, in the controller, the engine needs to be provided with means for detecting the fuel property.

The controller executes various processes in accordance with the amount of PM deposited on the filter. It is desired that the controller execute the processes executed in accordance with the amount of PM deposited on the filter at appropriate time without detecting the fuel property.

### SUMMARY

In an aspect of the present disclosure, a controller is configured to control an engine. The engine includes a filter configured to collect particulate matter in an exhaust pipe. The controller includes processing circuitry and a storage device. The storage device stores data of a first map that receives, as inputs, a rotation speed of the engine, a load of the engine, and a temperature of coolant of the engine and outputs an amount of particulate matter emitted from a combustion chamber of the engine when using a first fuel, and data of a second map that receives, as inputs, the rotation speed of the engine, the load of the engine, and the temperature of the coolant of the engine and outputs an amount of particulate matter emitted from the combustion chamber when using a second fuel. The second fuel differs in property from the first fuel. The processing circuitry is configured to execute, while the engine is running, calculate a first deposition amount based on an output value from the first map and a second deposition amount based on an output value from the second map as an amount of particulate matter deposited on the filter by inputting the rotation speed of the engine, the load of the engine, and the temperature of the coolant of the engine to the first map and the second map, respectively, execute a first process when the first deposition amount is greater than or equal to than a first threshold value, and execute a second process differing from the first process when the second deposition amount is greater than or equal to a second threshold value.

In an aspect of the present disclosure, a control method is executed by a controller configured to control an engine. The engine includes a filter disposed in an exhaust pipe and configured to collect particulate matter. The controller stores (i) a first map that outputs an amount of particulate matter emitted from a combustion chamber of the engine when a first fuel is assumed to be combusted in the combustion chamber based on a rotation speed of the engine, a load of the engine, and a temperature of coolant of the engine, and (ii) a second map that outputs an amount of particulate matter emitted from the combustion chamber when a second fuel is assumed to be combusted in the combustion chamber based on the rotation speed of the engine, the load of the engine, and the temperature of the coolant of the engine. The second fuel is less likely to produce particulate matter than the first fuel. The control method includes executing a first process routine and a second process routine in parallel with the first process routine. The first process routine includes calculating a first deposition amount using the first map, the first deposition amount being an amount of particulate matter estimated to be deposited on the filter when the first fuel is assumed to be combusted in the combustion chamber, and executing a filter protection process that reduces an amount of air supplied to the filter to avoid abnormal burning of the particulate matter deposited on the filter when the first deposition amount is greater than or equal to a first threshold value and a temperature of the filter is higher than or equal to a predetermined temperature. The second process routine includes calculating a second deposition amount using the second map, the second deposition amount being an amount of particulate matter estimated to be deposited on the filter when the second fuel is assumed to be combusted in the combustion chamber, and executing a filter regeneration process that increases a fuel injection amount to increase the temperature of the filter and then supplies air to the filter to burn and remove the particulate matter deposited on the filter when the second deposition amount is greater than or equal to a second threshold value that is greater than the first threshold value and an amount of fuel stored in a vehicle on which the engine is mounted is greater than or equal to a predetermined amount.

Other features and aspects will be apparent from the following detailed description, the drawings, and the claims.

### BRIEF DESCRIPTION OF THE DRAWINGS

FIG. 1 is a schematic diagram showing a configuration of a vehicle including a controller according to an embodiment.

FIG. 2A is a diagram showing a mode in which the controller of FIG. 1 calculates a first estimated emission amount.

FIG. 2B is a diagram showing a mode in which the controller of FIG. 1 calculates a second estimated emission amount.

FIG. 3 is a diagram showing a mode in which the controller of FIG. 1 calculates an amount of particulate matter deposited on a filter.

FIG. 4 is a time chart showing changes in first deposition amount and second deposition amount.

FIG. 5 is a flowchart showing a first process routine that is executed when the controller of FIG. 1 compares the first deposition amount with a first threshold value.

FIG. 6 is a flowchart showing a second process routine executed when the controller of FIG. 1 compares the second deposition amount with a second threshold value.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

Hereinafter, an embodiment of a controller will be described with reference to the drawings.

### Configuration of Vehicle 30

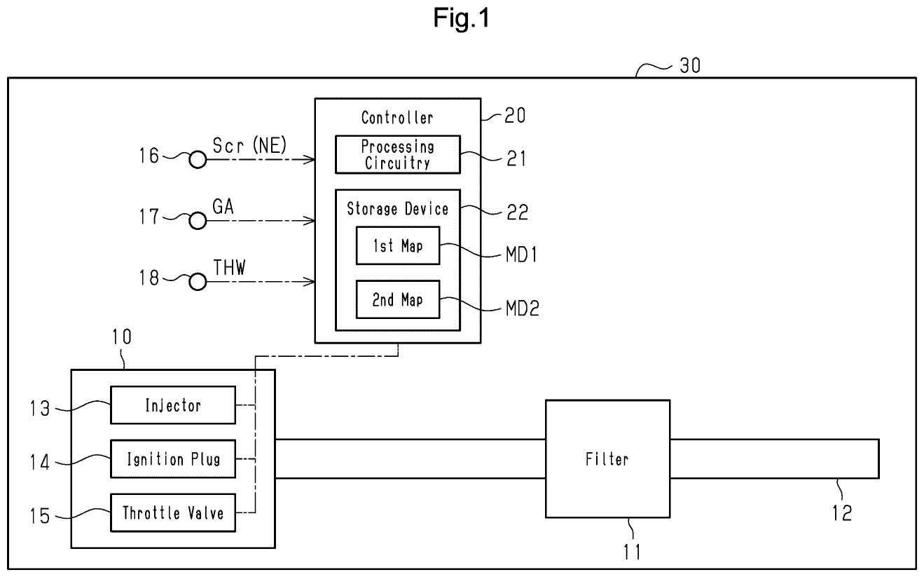

As shown in FIG. 1, the vehicle 30 includes an engine 10. The engine 10 uses gasoline as fuel.

The engine 10 includes an injector 13, an ignition plug 14, and a throttle valve 15. The injector 13 injects fuel into a cylinder of the engine 10. The ignition plug 14 ignites an air-fuel mixture in a cylinder of the engine 10. The throttle valve 15 is installed in an intake passage of the engine 10. The throttle valve 15 adjusts the amount of air sucked into the engine 10.

As shown in FIG. 1, an engine 10 includes a filter 11 in the middle of an exhaust pipe 12. The filter 11 collects particulate matter contained in the exhaust gas. A three way catalyst is carried on the filter 11.

Hereinafter, particulate matter may be referred to as PM. PM is an abbreviation of particulate matter.

As shown in FIG. 1, the vehicle 30 includes a crank angle sensor 16. The crank angle sensor 16 measures an angle of a crankshaft of the engine 10.

As shown in FIG. 1, the vehicle 30 includes an air flow meter 17. The air flow meter 17 is installed in an intake passage of the engine 10. The air flow meter 17 measures an intake air amount GA of the engine 10.

As shown in FIG. 1, the vehicle 30 includes a coolant temperature sensor 18. The coolant temperature sensor 18 measures a temperature THW of coolant of the engine 10.

As shown in FIG. 1, the vehicle 30 includes a controller 20. The controller 20 includes a processing circuitry 21 and a storage device 22.

The storage device 22 stores a program, a first map MD1, and a second map MD2. The processing circuitry 21 executes various kinds of processing by executing a program stored in the storage device 22. The processing circuitry 21 includes a processor. The first map MD1 and the second map MD2 will be described later.

The controller 20 controls the engine 10. Specifically, the controller 20 controls the injector 13, the ignition plug 14, and the throttle valve 15 in the engine 10. The controller 20 controls the amount of fuel injected into the cylinder of the engine 10 by controlling the injector 13. The controller 20 controls the ignition timing of the engine 10 by controlling the ignition plug 14. The controller 20 controls the amount of air sucked into the engine 10 by controlling the throttle valve 15.

The controller 20 is communicably connected to the crank angle sensor 16. The controller 20 acquires the output signal Scr of the crank angle sensor 16 through communication. Then, the controller 20 outputs the rotation speed NE of the engine 10 per unit time based on the time required for the crankshaft to rotate by a predetermined angle.

The controller 20 is communicably connected to the air flow meter 17. The controller 20 acquires the intake air amount GA measured by the air flow meter 17 through communication.

The controller 20 is communicably connected to the coolant temperature sensor 18. The controller 20 acquires the temperature THW of the coolant measured by the coolant temperature sensor 18 through communication.

When the amount of PM deposited on the filter 11 is large, abnormal combustion may occur in which the PM deposited on the filter 11 continues to burn. When the abnormal combustion occurs, the filter 11 is melted.

First, the controller 20 calculates the amount of PM emitted from the combustion chamber of the engine 10 based on the acquired various kinds of information. Thereafter, the controller 20 calculates the amount of PM deposited on the filter 11. When the amount of PM deposited on the filter 11 is large, the controller 20 executes a process for suppressing the occurrence of abnormal combustion.

### Mode in which Amount of PM Emitted from Combustion Chamber of Engine 10 is Calculated

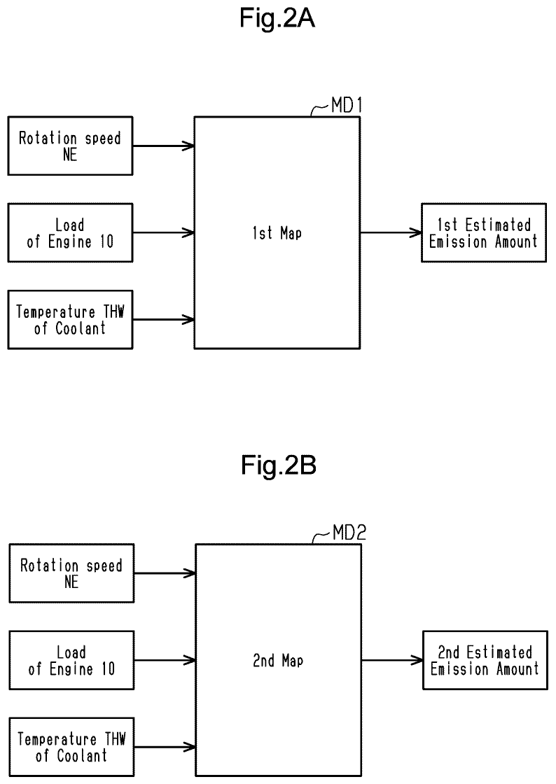

FIGS. 2A and 2B show a mode in which the controller 20 calculates the amount of PM emitted from the combustion chamber of the engine 10. The controller 20 calculates two kinds of values of a first estimated emission amount and a second estimated emission amount as the amount of PM emitted from the combustion chamber of the engine 10.

FIG. 2A shows a mode in which the controller 20 calculates the first estimated emission amount. As shown in FIG. 2A, the controller 20 calculates the first estimated emission amount by inputting the rotation speed NE of the engine 10, the load of the engine 10, and the temperature THW of the coolant of the engine 10 to a first map MD1.

The first map MD1 is a map that outputs the amount of PM emitted from the combustion chamber of the engine 10 in the case of using the first fuel when the rotation speed NE of the engine 10, the load of the engine 10, and the temperature THW of the coolant of the engine 10 are input. The first fuel is a fuel having a property of emitting the largest amount of particulate matter among fuels distributed in the market. For example, the creator of the first map MD1 creates the first map MD1 by using, as the first fuel, a fuel having a property of most easily generating PM during combustion, which is acquired in a sample survey using fuels distributed in the market as a population.

FIG. 2B shows a mode in which the controller 20 calculates the second estimated emission amount. As shown in FIG. 2B, the controller 20 calculates the second estimated emission amount by inputting the rotation speed NE of the engine 10, the load of the engine 10, and the temperature THW of the coolant of the engine 10 to the second map MD2.

The second map MD2 is a map that outputs the amount of particulate matter emitted from the combustion chamber of the engine 10 in the case of using the second fuel when the rotation speed NE of the engine 10, the load of the engine 10, and the temperature THW of the coolant of the engine 10 are input. The second fuel is a fuel having average properties among fuels distributed in the market. For example, the creator of the second map MD2 creates the second map MD2 by using, as the second fuel, a fuel having an average property in fuels acquired in a sample survey using fuels distributed in the market as a population.

As described above, the controller 20 can output the rotation speed NE of the engine 10 per unit time based on the output signal Scr of the crank angle sensor 16. In FIG. 2A, the controller 20 inputs the rotation speed NE of the engine 10 output by the controller 20 to the first map MD1. In FIG. 2B, the controller 20 inputs the rotation speed NE of the engine 10 output by the controller 20 to the second map MD2.

The load of the engine 10 is the ratio of the volume of air actually taken in in one cycle to the stroke volume per cycle of the engine 10. The controller 20 can output the load of the engine 10 based on the rotation speed NE of the engine 10 and the intake air amount GA acquired from the air flow meter 17. In FIG. 2A, the controller 20 inputs the output load of the engine 10 to the first map MD1. In FIG. 2B, the controller 20 inputs the output load of the engine 10 to the second map MD2.

In FIG. 2A, the controller 20 inputs the temperature THW of coolant of the engine 10 acquired from the coolant temperature sensor 18 to the first map MD1. In FIG. 2B, the controller 20 inputs the temperature THW of coolant of the engine 10 acquired from the coolant temperature sensor 18 to the second map MD2.

In this way, the controller 20 calculates two kinds of values as the amount of PM emitted from the combustion chamber of the engine 10 by inputting the rotation speed NE of the engine 10, the load of the engine 10, and the temperature THW of coolant of the engine 10 to two kinds of maps. The amount of PM emitted from the combustion chamber of the engine 10 when the first fuel is combusted is larger than that of the second fuel. Therefore, the first estimated emission amount calculated in FIG. 2A is larger than the second estimated emission amount calculated in FIG. 2B.

### Mode in Which Amount of PM Deposited on Filter 11 is Calculated

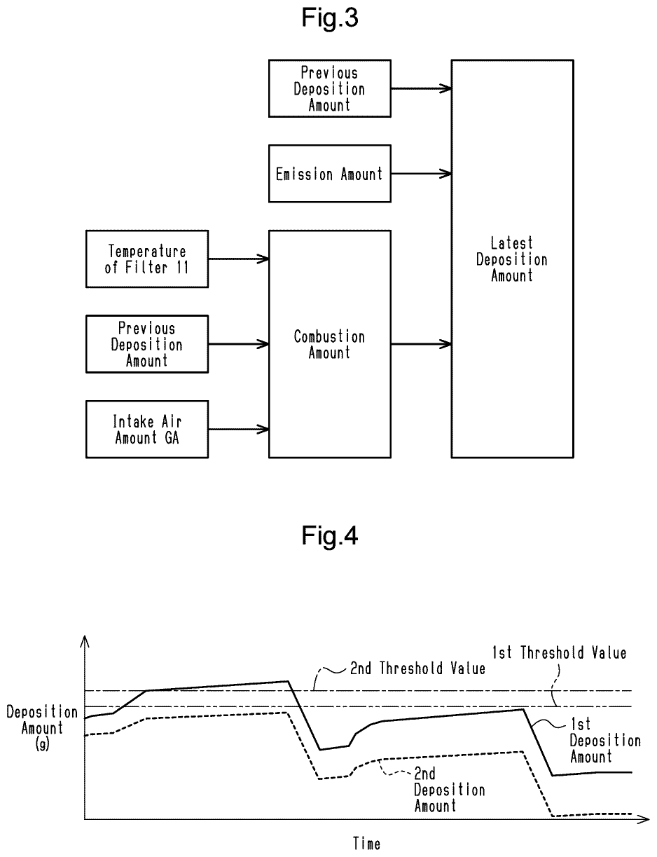

The controller 20 calculates the amount of PM deposited on the filter 11 after calculating the amount of PM emitted from the combustion chamber of the engine 10 in the manner shown in FIG. 2A and FIG. 2B. FIG. 3 shows a mode in which the controller 20 calculates the amount of PM deposited on the filter 11. The controller 20 periodically calculates the amount of PM deposited on the filter 11 in the manner shown in FIG. 3. Every time the controller 20 calculates the amount of PM deposited on the filter 11, the controller 20 stores the calculated value in the storage device 22, thereby updating the value stored in the storage device 22. Hereinafter, the amount of PM deposited on the filter 11 is referred to as a deposition amount.

As shown in FIG. 3, the controller 20 calculates the latest deposition amount based on the previous deposition amount, the PM emission amount, and the combustion amount of PM in the filter 11.

The previous deposition amount is a deposition amount previously calculated by the controller 20 in the manner shown in FIG. 3. In other words, the previous deposition amount is the value last stored by the storage device 22 as the latest deposition amount.

The emission amount of PM is the amount of PM emitted from the combustion chamber of the engine 10 calculated by the controller 20 in the manner shown in FIG. 2A and FIG. 2B.

The combustion amount of PM in the filter 11 is the amount of PM burned in the filter 11 from when the controller 20 acquires various kinds of information for calculating the previous deposition amount to when the controller 20 acquires various kinds of information for calculating the current deposition amount.

As shown in FIG. 3, the controller 20 calculates the combustion amount of PM based on the temperature of the filter 11, the previous deposition amount, and the intake air amount GA. At this time, the controller 20 calculates the temperature of the filter 11 based on the rotation speed NE of the engine 10 and the load of the engine 10. The controller 20 may acquire the temperature of the filter 11 from a sensor that measures the temperature of the filter 11.

The controller 20 calculates two kinds of values of a first deposition amount and a second deposition amount as the deposition amount.

The first deposition amount is an deposition amount calculated based on the first estimated emission amount, which is a value outputted from the first map MD1. The controller 20 calculates the first estimated emission amount in the manner shown in FIG. 2A, and then calculates the first deposition amount in the manner shown in FIG. 3 based on the first estimated emission amount.

At this time, the controller 20 uses the previously calculated first deposition amount as the previous deposition amount in FIG. 3. Further, the controller 20 uses the first estimated emission amount as the PM emission amount in FIG. 3. That is, the controller 20 calculates the latest first deposition amount based on the previously calculated first deposition amount, the first estimated emission amount, and the combustion amount of PM.

The second deposition amount is an deposition amount calculated based on the second estimated emission amount, which is a value outputted from the second map MD2. After calculating the second estimated emission amount in the manner shown in FIG. 2B, the controller 20 calculates the second deposition amount in the manner shown in FIG. 3 based on the second estimated emission amount.

At this time, the controller 20 uses the previously calculated second deposition amount as the previous deposition amount in FIG. 3. Further, the controller 20 uses the second estimated emission amount as the PM emission amount in FIG. 3. That is, the controller 20 calculates the latest second deposition amount based on the previously calculated second deposition amount, the second estimated emission amount, and the combustion amount of PM.

### Relationship Between First Deposition Amount and Second Deposition Amount

FIG. 4 shows an example of changes in the first deposition amount and the second deposition amount calculated by the controller 20. In FIG. 4, the first deposition amount is always larger than the second deposition amount.

As described above, the first estimated emission amount calculated in FIG. 2A is larger than the second estimated emission amount calculated in FIG. 2B. Therefore, the first deposition amount calculated based on the first estimated emission amount is greater than or equal to the second deposition amount calculated based on the second estimated emission amount. When the first deposition amount and the second deposition amount have the same value, both the first deposition amount and the second deposition amount are zero.

FIG. 4 shows the first threshold value and the second threshold value in addition to the change in the deposition amount. In FIG. 4, the first threshold value is smaller than the second threshold value. The first threshold is a value less than or equal to the second threshold.

After calculating the first deposition amount, the controller 20 compares the first deposition amount with the first threshold value. When it is determined that the first deposition amount is greater than or equal to the first threshold value, the controller 20 executes the first process. The first process will be described later.

After calculating the second deposition amount, the controller 20 compares the second deposition amount with the second threshold value. When the controller 20 determines that the second deposition amount is greater than or equal to the second threshold value, the controller 20 executes the second process. The second process will be described later.

Since the second deposition amount remains at a value less than or equal to the first deposition amount and the second threshold is equal to or more than the first threshold, the frequency at which the second deposition amount exceeds the second threshold is likely to be lower than the frequency at which the first deposition amount exceeds the first threshold. Therefore, the frequency of execution of the second process, which is executed on condition that the second deposition amount is greater than or equal to the second threshold value, tends to be lower than the frequency of execution of the first process, which is executed on condition that the first deposition amount is greater than or equal to the first threshold value.

A process executed when comparing the first deposition amount with the first threshold value.

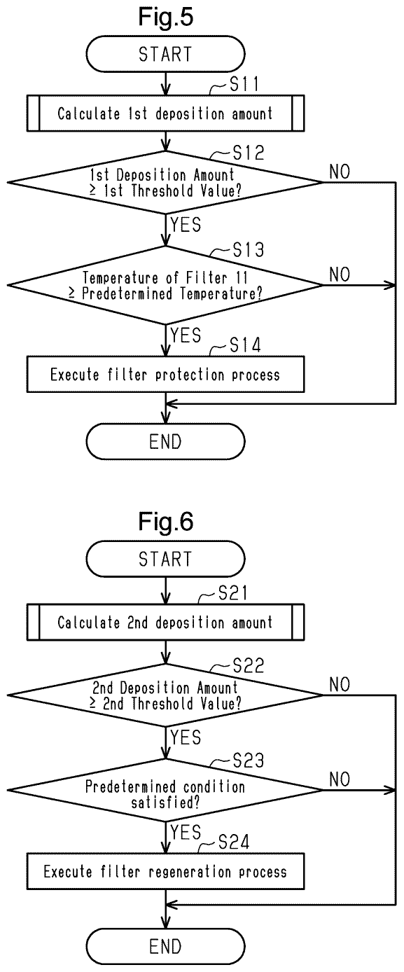

FIG. 5 is a flowchart showing a first process routine executed by the controller 20 when comparing the first deposition amount with the first threshold value. The series of processes illustrated in FIG. 5 is executed by the processing circuitry 21. The processing circuitry 21 periodically executes a series of processes shown in FIG. 5 during the operation of the engine 10. In FIG. 5, S means a step.

When starting the series of processes illustrated in FIG. 5, the processing circuitry 21 first executes a S11 process. In the S11 processing, the processing circuitry 21 calculates a first deposition amount. At this time, the processing circuitry 21 first calculates the first estimated emission amount in the manner shown in FIG. 2A. Thereafter, the processing circuitry 21 calculates the first deposition amount in the manner shown in FIG. 3 based on the first estimated emission amount.

Thereafter, the processing circuitry 21 performs S12 processing. In the process of S12, the processing circuitry 21 determines whether or not the first deposition amount calculated in the process of S11 is greater than or equal to a first reference value.

When the processing circuitry 21 determines that the first deposition amount is less than the first reference value in the process of S12 (S12: NO), the processing circuitry 21 ends the series of processes shown in FIG. 5. On the other hand, when the processing circuitry 21 determines that the first deposition amount is equal to or greater than the first reference value in the processing of S12 (S12: YES), the processing proceeds to S13.

In the S13 process, the processing circuitry 21 determines whether or not the temperature of the filter 11 is higher than or equal to a predetermined temperature. At this time, the controller 20 may compare the temperature of the filter 11 acquired for calculating the first deposition amount with the predetermined temperature, or may acquire the temperature of the filter 11 again when the processing of the S13 is performed and compare the acquired temperature of the filter 11 with the predetermined temperature.

When the processing circuitry 21 determines in the process of S13 that the temperature of the filter 11 is lower than the predetermined temperature (S13: NO), the processing circuitry 21 ends the series of processes shown in FIG. 5. On the other hand, when the processing circuitry 21 determines in the process of S13 that the temperature of the filter 11 is higher than or equal to the predetermined temperature (S13: YES), the processing circuitry 21 advances the process to S14.

In the S14 process, the processing circuitry 21 executes a filter protection process. The filter protection process is a first process.

The filter protection process is a process for suppressing the occurrence of abnormal combustion of the PM deposited on the filter 11 by reducing the amount of air supplied to the filter 11. Specifically, in the filter protection process, the processing circuitry 21 reduces the amount of air supplied to the filter 11 by causing the injector 13 to inject fuel in a situation where a fuel cut is normally executed. By reducing the amount of air supplied to the filter 11, the oxidation reaction of PM becomes less likely to occur, and the occurrence of abnormal combustion is suppressed. The situation in which the fuel cut is normally executed is, for example, when the user of the vehicle 30 does not depress the accelerator pedal and the vehicle 30 is decelerating.

After executing the filter protection process, the processing circuitry 21 ends the series of processes illustrated in FIG. 5.

A process executed when comparing the second deposition amount with the second threshold value.

FIG. 6 is a flowchart showing a second process routine executed when the controller 20 compares the second deposition amount with the second threshold value. The series of processes illustrated in FIG. 6 is executed by the processing circuitry 21. The processing circuitry 21 periodically executes a series of processes shown in FIG. 6 during the operation of the engine 10. That is, the processing circuitry 21 executes the second process routine in parallel with the first process routine. In FIG. 6, S means a step.

When starting the series of processes illustrated in FIG. 6, the processing circuitry 21 first executes a S21 process. In the processing of the S21, the processing circuitry 21 calculates the second deposition amount. At this time, the processing circuitry 21 first calculates the second estimated emission amount in the manner shown in FIG. 2B. Thereafter, the processing circuitry 21 calculates the second deposition amount in the manner shown in FIG. 3 based on the second estimated emission amount.

Thereafter, the processing circuitry 21 performs S22 processing. In the processing of S22, the processing circuitry 21 determines whether or not the second deposition amount calculated in the processing of S21 is greater than or equal to a second reference value.

When it is determined in the process of S22 that the second deposition amount is less than the second reference value (S22: NO), the processing circuitry 21 ends the series of processes shown in FIG. 6. On the other hand, when the processing circuitry 21 determines that the second deposition amount is greater than or equal to the second reference value in the processing of S22 (S22: YES), the processing proceeds to S23.

In the S23 process, the processing circuitry 21 determines whether or not a predetermined condition is satisfied. The predetermined condition is set such that the traveling of the vehicle 30 is not significantly affected even when the second process is executed. In a second process described later, the fuel efficiency of the vehicle 30 is deteriorated. The predetermined condition is, for example, that the amount of fuel stored in the vehicle 30 is greater than or equal to a predetermined amount. In this case, the processing circuitry 21 determines that the predetermined condition is not satisfied when the amount of fuel stored in the vehicle 30 is smaller than a predetermined amount.

When it is determined in the process of S23 that the predetermined condition is not satisfied (S23: NO), the processing circuitry 21 ends the series of processes illustrated in FIG. 6. On the other hand, when the processing circuitry 21 determines that the predetermined condition is satisfied in the processing of S23 (S23: YES), the processing proceeds to S24.

In the S24 process, the processing circuitry 21 performs a filter restoration process. The filter regeneration process is a second process.

The filter regeneration process is a process of burning and removing the PM deposited on the filter 11. In the filter regeneration process, the processing circuitry 21 increases the fuel injection amount to raise the temperature of the filter 11, and then supplies air to the filter 11 to burn the PM deposited on the filter 11.

For example, the processing circuitry 21 causes the activated three way catalyst to oxidize the unburned fuel by supplying the unburned fuel to the filter 11 having a high temperature, and causes the temperature of the filter 11 to rise due to the heat generated by the oxidation reaction. For example, the processing circuitry 21 can supply unburned fuel to the filter 11 by causing the injector 13 to inject fuel in a state in which ignition by the ignition plug 14 is stopped.

For example, the processing circuitry 21 may increase the temperature of the exhaust gas by retarding the ignition timing of the ignition plug 14. In this case as well, the filter 11 is warmed by the exhaust gas and the temperature thereof rises. Note that when the ignition timing is, the generated torque decreases, so the amount of fuel injection required to generate the same torque increases. Therefore, even when the temperature is increased by retarding the ignition timing, the fuel injection amount is increased.

In the filter regeneration process, the processing circuitry 21 raises the temperature of the filter 11 and then supplies air to the filter 11. The processing circuitry 21 supplies the air in the cylinder to the filter 11 by the pumping action due to the rise and fall of the piston in a state where the injection of the fuel by the injector 13 is stopped. At this time, for example, the processing circuitry 21 may stop the injection of fuel by the injector 13 for a part of the cylinders of the engine 10 to supply the air in the part of the cylinders to the filter 11. In the filter regeneration process, if the temperature of the filter 11 is originally high, the processing circuitry 21 may supply air to the filter 11 without executing the control for increasing the temperature of the filter 11.

The processing circuitry 21 may perform dither control in the filter regeneration process. The dither control is control in which the air-fuel ratio in some of the cylinders in the engine 10 is made richer than the stoichiometric air-fuel ratio and the air-fuel ratio in the other cylinders is made leaner than the stoichiometric air-fuel ratio.

After executing the filter regeneration process, the processing circuitry 21 ends the series of processes illustrated in FIG. 6.

### Effect of the Present Embodiment

The controller 20 changes the map used for calculating the amount of PM deposited on the filter 11 in accordance with the process to be executed.

### Advantages of the Present Embodiment

(1) The controller 20 executes each of the processes that are executed in accordance with the amount of PM deposited on the filter 11 at an appropriate frequency.
(2) The first fuel has a property such that PM emission is highest among commercially available fuels. The second fuel has an average property among the commercially available fuels.

The controller 20 calculates a first deposition amount based on an assumption that the engine 10 is running using the first fuel, which has a property such that PM emission is highest, and a second deposition amount based on an assumption that the engine 10 is running using the second fuel, which has an average property.
(3) The second threshold value is greater than or equal to the first threshold value. The processing circuitry 21 is configured to execute, as the second process, a filter regeneration process that increases the fuel injection amount to increase the temperature of the filter 11 and then supplies air to the filter 11 to burn and remove PM deposited on the filter 11.

The filter regeneration process is executed to eliminate clogging of the filter 11. For example, the filter regeneration process increases the temperature of the filter 11 by increasing the fuel injection amount or retarding the ignition timing. Therefore, when the filter regeneration process is executed frequently, the fuel efficiency of the vehicle 30 deteriorates. In this regard, the controller 20 executes the filter regenerating process based on the second deposition amount, which is calculated based on a value output from the second map MD2. The second map MD2 outputs a smaller value than the first map MD1. Thus, the controller 20 limits deterioration of the fuel efficiency caused by the frequent execution of the filter regeneration process.
(4) The first threshold value is less than or equal to the second threshold value. The processing circuitry 21 is configured to execute, as the first process, a filter protection process that reduces the amount of air supplied to the filter 11 to avoid abnormal burning of PM deposited in the filter 11.

If the filter protection process is not reliably executed at appropriate time, abnormal combustion may occur in which the PM deposited on the filter 11 continues to burn. This may melt and damage the filter 11, Therefore, it is desirable that the filter protection process be sufficiently executed even by allowing frequent execution of the filter protection process. The first deposition amount is calculated based on a value output from the first map MD1, which is used with an assumption that the engine 10 is running using a fuel having a property such that PM emission is high. Therefore, the first deposition amount is greater than or equal to the second deposition amount. The controller 20 executes the filter protection process based on the first deposition amount. Thus, the controller 20 executes the filter protection process sufficiently frequently.
(5) The processing circuitry 21 does not execute the filter protection process when the temperature of the filter 11 is lower than the predetermined temperature even when the first deposition amount is greater than or equal to the first threshold value.

When the temperature of the filter 11 is low, abnormal combustion of PM does not occur. The controller 20 does not execute the filter protection process when the temperature of the filter 11 is low. Thus, the controller 20 limits execution of the filter protection process when abnormal combustion is less likely to occur.

### Modifications

The embodiments described above may be modified as follows. The above embodiment and the following modifications can be combined as long as the combined modifications remain technically consistent with each other.

The engine 10 may be a diesel engine using light oil as fuel.

The vehicle 30 may be a hybrid vehicle including a motor in addition to the engine 10.

In the above embodiment, two maps assuming different fuels are prepared, and two estimated emissions are calculated. If the first fuel and the second fuel are different fuels, the first fuel may be a fuel having an average property among fuels distributed in the market. If the first fuel and the second fuel are different fuels, the first fuel may be a fuel having a property of emitting the least amount of PM among fuels distributed in the market.

When the first fuel and the second fuel are different fuels, the second fuel may be a fuel having a property of emitting the largest amount of PM among fuels distributed in the market. If the first fuel and the second fuel are different fuels, the second fuel may be a fuel having a property of emitting the least amount of PM among fuels distributed in the market.

The magnitude relationship between the first threshold value and the second threshold value is not limited to the aspect illustrated in FIG. 4. Since the threshold value may be set in accordance with the property of the fuel or the content of the process to be executed, the second threshold value may be a value less than the first threshold value.

The controller 20 of the above-mentioned embodiment changes the map used for calculating the deposition amount in accordance with the process to be executed, and thereby can execute each of the first process and the second process, which are different processes, at an appropriate timing.

The first process does not have to be the filter protection process as long as the first process and the second process are different processes and the frequency at which the processes are executed based on the result of the comparison between the first deposition amount and the first threshold value is appropriate. For example, if the first process and the second process are different processes and the frequency of execution based on the result of the magnitude comparison between the first deposition amount and the first threshold value is appropriate, the first process may be a process of notifying a user or the like of the vehicle 30 that the amount of PM deposited on the filter 11 has increased.

The second process may not be the filter regeneration process as long as the first process and the second process are different processes and the frequency at which the second process is executed based on the result of the comparison between the second deposition amount and the second threshold value is appropriate. For example, if the first process and the second process are different processes and the frequency of execution based on the result of the magnitude comparison between the second deposition amount and the second threshold value is appropriate, the second process may be a process of notifying the user or the like of the vehicle 30 that the amount of PM deposited on the filter 11 has increased.

The processing circuitry 21 may execute the filter protection process even when the temperature of the filter 11 is lower than the predetermined temperature.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller configured to control an engine, the engine including a filter configured to collect particulate matter in an exhaust pipe, the controller comprising:
processing circuitry; and
a storage device, wherein
the storage device stores:
data of a first map that receives, as inputs, a rotation speed of the engine, a load of the engine, and a temperature of coolant of the engine and outputs an amount of particulate matter emitted from a combustion chamber of the engine when using a first fuel; and
data of a second map that receives, as inputs, the rotation speed of the engine, the load of the engine, and the temperature of the coolant of the engine and outputs an amount of particulate matter emitted from the combustion chamber when using a second fuel, the second fuel differing in property from the first fuel, the processing circuitry is configured, while the engine is running, to:
calculate a first deposition amount based on an output value from the first map and a second deposition amount based on an output value from the second map as an amount of particulate matter deposited on the filter by inputting the rotation speed of the engine, the load of the engine, and the temperature of the coolant of the engine to the first map and the second map, respectively;
execute a first process when the first deposition amount is greater than or equal to than a first threshold value; and
execute a second process differing from the first process when the second deposition amount is greater than or equal to a second threshold value.

2. The controller according to claim 1, wherein
the first fuel has a property such that emission of particulate matter is highest among commercially available fuels, and
the second fuel has an average property among the commercially available fuels.

3. The controller according to claim 2, wherein
the second threshold value is greater than or equal to the first threshold value, and
the processing circuitry is configured to execute, as the second process, a filter regeneration process that increases a fuel injection amount to increase a temperature of the filter and then supplies air to the filter to burn and remove the particulate matter deposited on the filter.

4. The controller according to claim 2, wherein
the first threshold value is less than or equal to the second threshold value, and
the processing circuitry is configured to execute, as the first process, a filter protection process that reduces an amount of air supplied to the filter to avoid abnormal burning of the particulate matter deposited on the filter.

5. The controller according to claim 4, wherein the processing circuitry is configured not to execute the filter protection process when the temperature of the filter is lower than a predetermined temperature even when the first deposition amount is greater than or equal to the first threshold value.

6. A control method executed by a controller configured to control an engine, the engine including a filter disposed in an exhaust pipe and configured to collect particulate matter, the controller storing (i) a first map that outputs an amount of particulate matter emitted from a combustion chamber of the engine when a first fuel is assumed to be combusted in the combustion chamber based on a rotation speed of the engine, a load of the engine, and a temperature of coolant of the engine, and (ii) a second map that outputs an amount of particulate matter emitted from the combustion chamber when a second fuel is assumed to be combusted in the combustion chamber based on the rotation speed of the engine, the load of the engine, and the temperature of the coolant of the engine, the second fuel being less likely to produce particulate matter than the first fuel, the control method, comprising:
executing a first process routine including
calculating a first deposition amount using the first map, the first deposition amount being an amount of particulate matter estimated to be deposited on the filter when the first fuel is assumed to be combusted in the combustion chamber, and
executing a filter protection process that reduces an amount of air supplied to the filter to avoid abnormal burning of the particulate matter deposited on the filter when the first deposition amount is greater than or equal to a first threshold value and a temperature of the filter is higher than or equal to a predetermined temperature; and
executing a second process routine in parallel with the first process routine, the second process routine including
calculating a second deposition amount using the second map, the second deposition amount being an amount of particulate matter estimated to be deposited on the filter when the second fuel is assumed to be combusted in the combustion chamber, and
executing a filter regeneration process that increases a fuel injection amount to increase the temperature of the filter and then supplies air to the filter to burn and remove the particulate matter deposited on the filter when the second deposition amount is greater than or equal to a second threshold value that is greater than the first threshold value and an amount of fuel stored in a vehicle on which the engine is mounted is greater than or equal to a predetermined amount.
